(19) United States
(12) Patent Application Publication
(10) Pub. No.: US 2010/0014618 A1
(43) Pub. Date: Jan. 21, 2010

(54) RECEIVING DEVICE

(75) Inventors: Yasunobu Tsukio, Osaka (JP); Hiroaki Ozeki, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/375,324

(22) PCT Filed: Nov. 13, 2007
(86) PCT No.: PCT/JP2007/071969

§ 371 Date: Jan. 27, 2009

(30) Foreign Application Priority Data
Nov. 29, 2006 (JP) 2006-321484

(51) Int. Cl. H04B 1/06; H04B 7/00; H04L 27/08

(52) U.S. Cl. 375/345; 455/232.1; 455/254

(57) ABSTRACT

When performing switching control of reception modes trading off reception sensitivity against power consumption in a reception environment, the receiving apparatus and control method of the present invention perform state transition without a reception error occurring due to switching control with the aid of a reception mode in which an intermediate reception performance is provided. The present invention is particularly useful to balance the reception performance with the battery duration in a battery-powered, portable receiving terminal such as a television receiver for a mobile terminal.

### TECHNICAL FIELD

The present invention relates to a receiving apparatus selecting an appropriate reception mode trading off reception performance against operation power according to a reception environment.

### BACKGROUND ART

In recent years, diversity reception method has been employed for small, mobile receiving terminals. That is, a small terminal usually has a low-gain antenna to reduce the size of its receiving antenna, and is used in an adverse reception environment, where the user performs reception while moving, for example. In response, diversity reception significantly improves reception sensitivity, where two antennas are used, and either one of the signals is selected or both signals are synthesized.

However, diversity reception method has two series of antennas and receivers, and thus an increase of power consumption becomes a problem with a battery-powered mobile terminal. Under the circumstances, a method is proposed that satisfies both of improving reception performance and reducing power consumption. That is, high sensitivity precedes with diversity reception in an adverse reception environment; low power consumption precedes with receiving with one-series receiver alone (referred to as single reception, hereinafter) in a favorable reception environment.

As prior art document information related to this patent application, patent literature 1 is known, for example. However, diversity reception has significantly favorable reception sensitivity compared to single reception, resulting in frequent switching between diversity reception and single reception when switching control is performed according to a reception environment, which may cause a reception error. More specifically, at an input level between that for a reception sensitivity in diversity reception and that in single reception, switching between diversity reception and single reception occurs frequently because an input level range exists in which reception cannot be performed by single reception but can be by diversity reception with a sufficient margin.

FIG. 7 is an example control flow of a conventional case where switching is performed between the diversity reception mode and single reception mode. First, controller 9 (refer to FIG. 4) acquires a BER output from BER measuring unit 8 (refer to FIG. 4). Next, when the current mode is the diversity reception mode, controller 9 compares the BER with the release threshold. When the BER is lower than the release threshold (Yes), which means the reception environment is favorable, controller 9 controls so as to switch to the single reception mode; when the BER is higher than the release threshold (No), controller 9 does not perform switching control, but the flow returns to the BER acquiring step. Meanwhile, when the current mode is the single reception mode, controller 9 compares the BER with the start-up threshold. When the BER is higher than the start-up threshold (Yes), which means the reception environment is adverse, controller 9 controls so as to switch to the diversity reception mode; when the BER is lower than the start-up threshold (No), controller 9 does not perform switching control, but the flow returns to the BER acquiring step. The difference in sensitivity between the diversity reception mode and single reception mode is as large as approximately 3 dB, and thus switching between the reception modes occurs periodically because level range A exists as described above, and additionally a reception error occurs because level range B exists.
[Patent literature 1] Japanese Patent Unexamined Publication No. H11-150497

### SUMMARY OF THE INVENTION

The present invention improves conventional disadvantages, eliminates switching between reception modes frequently, and prevents a reception error. A receiving apparatus of the present invention includes a receiver capable of switching between a high-sensitivity mode, a power-saving mode having a reception sensitivity lower than that in the high-sensitivity mode, and an intermediate reception mode having a reception sensitivity lower than that in the high-sensitivity mode and higher than that in the power-saving mode; and a reception environment acquiring unit acquiring a reception environment, connected to the output side of the receiver. The receiving apparatus further includes a controller that switches the receiver, if the receiver is in the high-sensitivity mode, to the intermediate reception mode when a reception environment acquired by the reception environment acquiring unit becomes better than the release threshold; and if the receiver is in the intermediate reception mode, to the power-saving mode when a reception environment acquired by the reception environment acquiring unit becomes better than the first threshold. With this configuration, the difference in sensitivity between the high-sensitivity mode and intermediate reception mode, and that between the intermediate reception mode and power-saving mode are smaller than that between the high-sensitivity mode and power-saving mode, thereby preventing frequent switching caused by a large difference in sensitivity between the reception modes at switching control. That is, state transition between the reception modes are performed while suppressing a reception error occurring.

### BRIEF DESCRIPTION OF DRAWINGS

FIG. 1 is an operation flowchart of a receiving apparatus of the present invention.

FIG. 2 shows reception sensitivity characteristics in the diversity reception mode and single reception mode of the present invention.

FIG. 3 is a block diagram of a receiver according to the present invention.

FIG. 4 is a block diagram of a receiving apparatus according to the present invention.

FIG. 5 shows reception sensitivity characteristics in a conventional diversity reception mode and single reception mode.

FIG. 6 shows detailed reception sensitivity characteristics in a conventional diversity reception mode and single reception mode.

FIG. 7 is an operation flowchart of a conventional receiving apparatus.

### REFERENCE MARKS IN THE DRAWINGS

1 Receiving apparatus
2 First receiver
3 Second receiver
4 Diversity processing unit
5 Error corrector
6 Decoder
7 Display unit
8 BER measuring unit
9 Controller
10 Receiver
11 Antenna
12 RF filter
13 RFGCA
14 Mixer
15 VCO
16 RFAGC
17 IF filter
18 IFGCA
19 ADC
20 Demodulator

### DETAILED DESCRIPTION OF PREFERRED EMBODIMENTS

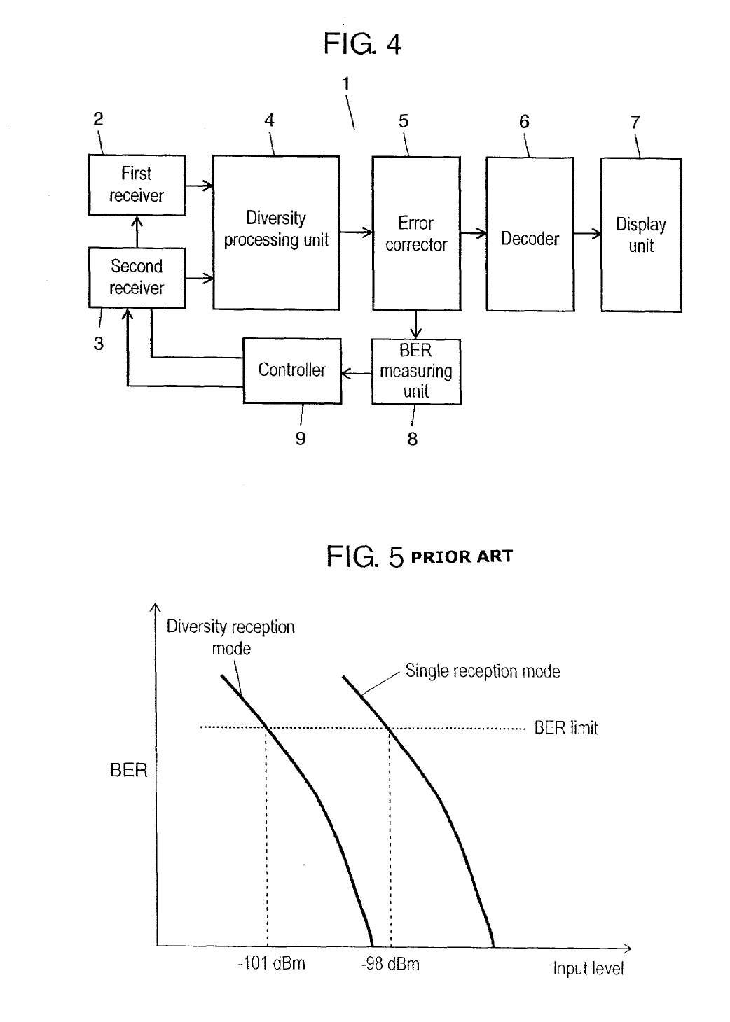

Hereinafter, a description is made for a concrete exemplary embodiment according to the present invention. In FIG. 4, receiving apparatus 1 includes first receiver 2; second receiver 3; and diversity processing unit 4 connected to the output sides of first receiver 2 and second receiver 3. Receiving apparatus 1 further includes error corrector 5 connected to the output side of diversity processing unit 4; decoder 6 connected to the output side of error corrector 5; display unit 7 connected to the output side of decoder 6; BER (bit error rate) measuring unit 8 connected to error corrector 5; and controller 9 controlling first receiver 2 and second receiver 3 according to a signal from BER measuring unit 8. Similar configurations of receiving apparatus 1 include one having all of these components and one having one or more of the components.

With the configuration, receiving apparatus 1 operates in the diversity reception mode, where diversity processing is performed with first receiver 2 and second receiver 3; and in the single reception mode, where only one of first receiver 2 and second receiver 3 is used and the other is powered off. In whichever reception mode, decoder 6 can restore a signal output from error corrector 5 to data for the transmission side, and display unit 7 can display the data restored.

FIG. 5 shows reception sensitivity characteristics in the diversity reception mode and single reception mode. The horizontal axis represents the input level to the receiver; the vertical axis, the error rate (BER) of a reception signal. A reception sensitivity is generally defined by an input level at which the BER reaches a limit value (BER limit, hereinafter) below which the decoder can restore transmission data normally. In the example of FIG. 5, the reception sensitivity in the single reception mode is −98 dBm and that in the diversity reception mode is −101 dBm, which means the diversity reception mode has a sensitivity better than that in the single reception mode by 3 dB. Meanwhile, the receiver composed of a high-frequency circuit, which generally consumes large power, consumes significantly large power in the diversity reception mode compared to the single reception mode, where one of the receivers is powered off. Here, the values (−98 dBm, −101 dBm, 3 dB) in the above example, varying depending on the performance of receiving apparatus 1, are shown by way of example.

In FIG. 4, controller 9 performs switching control between the diversity reception mode and single reception mode according to a reception environment. Means for acquiring a reception environment include various methods such as those using automatic gain control (AGC), carrier-to-noise (C/N) ratio, and BER, where a method of using BER is described as an example in this embodiment. That is, when a BER output from BER measuring unit 8 (i.e. reception environment acquiring unit) is lower than a threshold preliminarily set, the input level to the receiver is high, which is judged as a favorable reception environment, and the reception mode is switched from the diversity reception mode with high sensitivity to the single reception mode with low sensitivity. Hereinafter, a threshold of a BER at which switching is performed from the diversity reception mode to the single reception mode is referred to as a release threshold. Meanwhile, when a BER output from BER measuring unit 8 is higher than a threshold preliminarily set, the input level to the receiver is low, which is judged as an adverse reception environment, and the reception mode is switched from the single reception mode with low sensitivity to the diversity reception mode with high sensitivity. Hereinafter, a threshold of a BER at which switching is performed from the single reception mode to the diversity reception mode is referred to as a start-up threshold. Owing to this control, the power consumption is reduced in the single reception mode for a favorable reception environment; the reception performance is ensured in the diversity reception mode for an adverse reception environment.

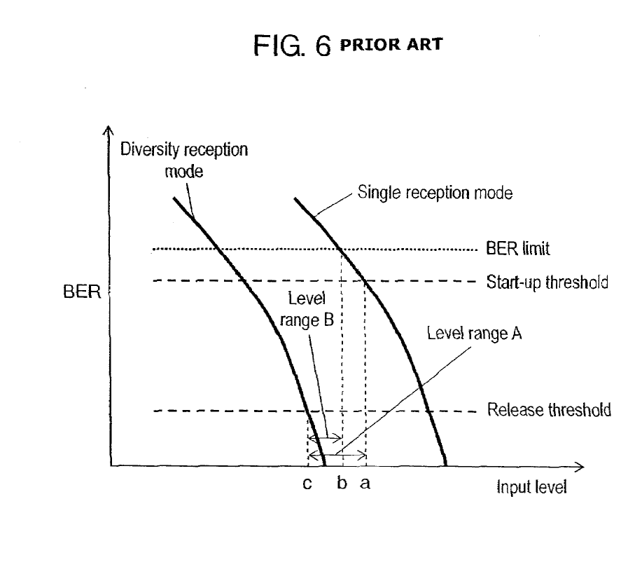

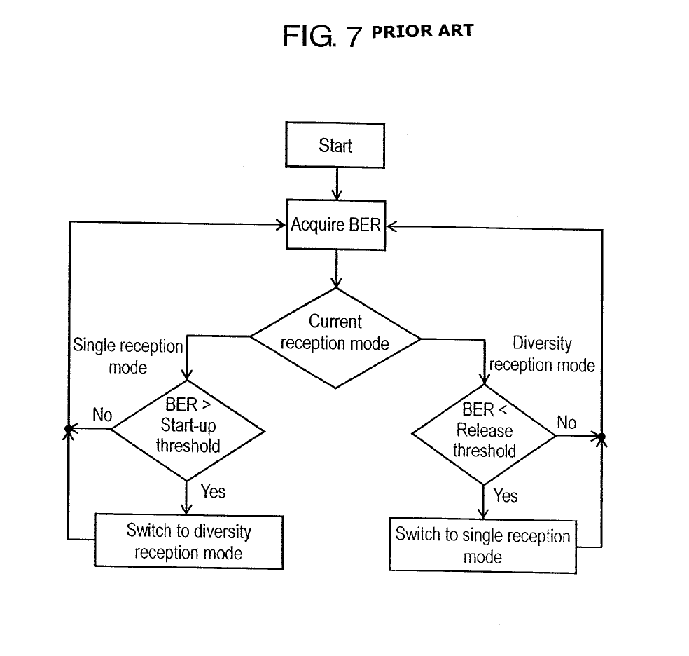

However, the difference in reception sensitivity between the single reception mode and diversity reception mode is as large as approximately 3 dB, and thus switching occurs frequently at an intermediate input level between them. This phenomenon is described using FIG. 6, which shows the release threshold and start-up threshold aforementioned. In a level range (level range A, hereinafter) lower than input level a at which the start-up threshold is reached in the single reception mode and additionally higher than input level c at which the release threshold is reached in the diversity reception mode, if the receiver is in the single reception mode, the BER is higher than the start-up threshold in and thus controller 9 switches the reception mode to the diversity reception mode; and if the receiver is in the diversity reception mode, the BER is lower than the release threshold, and thus controller 9 switches the reception mode to the single reception mode. Consequently, switching occurs periodically between the single reception mode and diversity reception mode, and when receiving apparatus 1 is steadily present in this level range A, switching between the reception modes occurs frequently.

Furthermore, in a level range (level range B, hereinafter) lower than input level b (i.e. sensitivity level) at which the error limit is reached in the single reception mode and additionally higher than input level c at which the release threshold is reached in the diversity reception mode, switching occurs periodically, generating a reception error. That is to say, errors exceeding the BER limit occur during the single reception mode, and thus decoder 6 at the subsequent stage cannot restore transmission data normally. Here, level range A and level range B can be narrowed by setting a low value to the release threshold. However, to do so, the measurement accuracy for a BER needs to be raised. For this reason, the measurement time needs to be prolonged, which reduces the following capability to the change of the reception environment. In digital broadcasting (one-segment broadcasting) for mobile terminals as a concrete example, the data transmission speed of an MPEG transport stream (TS) is approximately 416 kbps, and thus to measure the BER to an accuracy of 1E-6, measurement needs to be made for approximately 2 seconds, which is not allowable in terms of following capability in adaptive control.

Under the circumstances, the present invention employs a third reception mode (referred to as intermediate reception mode, hereinafter) having a reception sensitivity lower than that in the diversity reception mode and higher than that in the single reception mode. An intermediate reception mode can be created by deteriorating the sensitivity in the diversity reception mode any way.

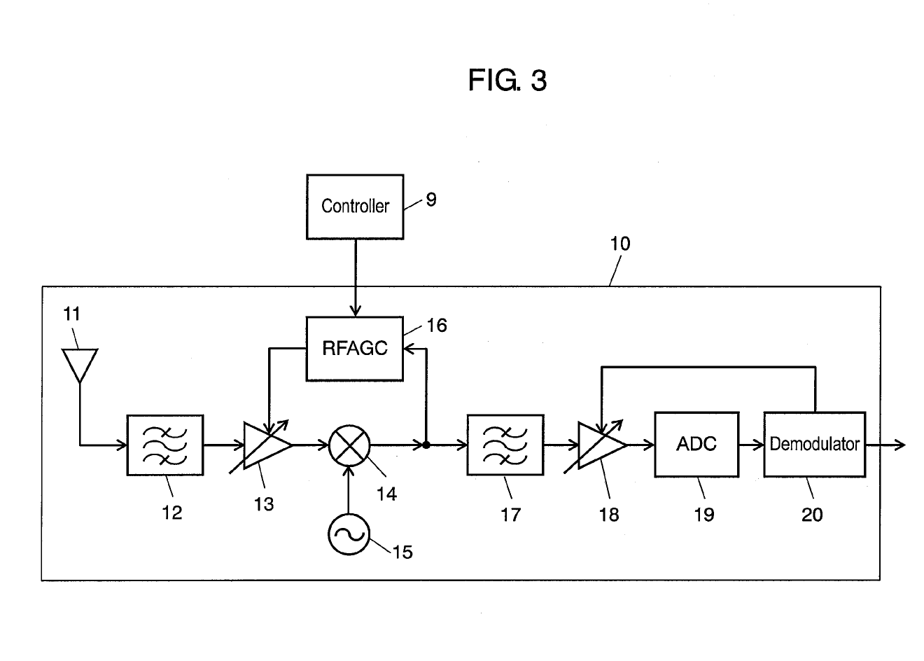

As an example of creating an intermediate reception mode, there is a method that lowers the gain of an RFGCA (radio frequency gain control amplifier) contained in the receiver, which is described using FIG. 3. Receiver 10 in FIG. 3 corresponds to first receiver 2 or second receiver 3 in FIG. 4. In FIG. 3, receiver 10 is composed of antenna 11; RF filter 12 connected to antenna 11; RFGCA 13 connected to RF filter 12 and RFAGC (radio frequency automatic gain control) 16 (described later); VCO (voltage controlled oscillator) 15; mixer 14 connected to RFGCA 13 and VCO 15; IF filter 17 connected to mixer 14; IFGCA 18 connected to IF filter 17; ADC (analog digital converter) 19 connected to IFGCA 18; demodulating unit 20 connected to ADC 19; and RFAGC 16 connected to mixer 14. Controller 9 located outside receiver 10 is connected to RFAGC 16. With this configuration, receiver 10 suppresses unnecessary waves contained in a reception signal received by antenna 11 using RF filter 12, and controls so that the signal level falls within a given level range using RFGCA 13. Next, receiver 10 mixes a local signal output from VCO 15 with an output signal from RFGCA 13 using mixer 14 to convert it to a predetermined intermediate frequency (IF). Next, receiver 10 removes unnecessary waves other than those in a given band from an output signal from mixer 14 with IF filter 17 to perform the final signal filtration, and then performs gain control with IFGCA 18 so that the input range of ADC 19 is met. Next, receiver 10 A/D-converts an output signal from IFGCA 18 to a digital signal with ADC 19 (i.e. A/D converter) and demodulates it with demodulating unit 20 to be connected to the diversity processing unit (not shown) in the subsequent stage. Reception sensitivity S of a receiving apparatus is generally defined by a noise figure determined by a signal band width and temperature; noise figure F determined by the configuration of the receiver; and a required C/N determined by a modulation method of a signal, which is expressed by expression (1) below, where K represents the Boltzmann constant; T, temperature; and B, signal band width.

S=KTB+F+C/N (1)

Here, a description is made that the reception sensitivity can be deteriorated by lowering the gain of RFGCA 13. Assuming that the gain of the RFGCA is G1, the noise figure is F1, and the noise figure subsequent to mixer 14 (included) is F2, then noise figure F of the entire receiver is expressed by expression (2) below.

F=F1+(F2−1)÷G1 (2)

That is to say, reducing gain G1 of the RFGCA increases noise figure F of the entire receiving apparatus, which consequently increases the reception sensitivity S of the receiving apparatus in expression (1), causing the reception sensitivity to deteriorate. With the aid of this relationship, controller 9 forcibly sets a control value to RFAGC 16 controlling the gain of RFGCA 13 for the two series of receivers (i.e. first receiver 2, second receiver 3) in the diversity reception mode. As a result, an intermediate reception mode is created that has a reception sensitivity lower than that in the diversity reception mode and higher than that in the single reception mode.

Besides this method, the next means can be utilized as a means of creating an intermediate reception mode. That is, by restricting (reducing) a current value of each circuit in receiver 10 to restrict the amplification degree of the transistors, the gain and noise figure are deteriorated, which causes the reception sensitivity to deteriorate. In this case, less power is consumed during a period of the intermediate reception mode than the diversity reception mode, which is more effective to reduce power consumption. Alternatively, an intermediate reception mode can be created by decreasing the conversion accuracy of A/D conversion in ADC 19 to deteriorate the sensitivity. Although other methods of creating an intermediate reception mode exist, the present invention has curative properties against a reception error caused by periodic switching independently of a way an intermediate reception mode is created.

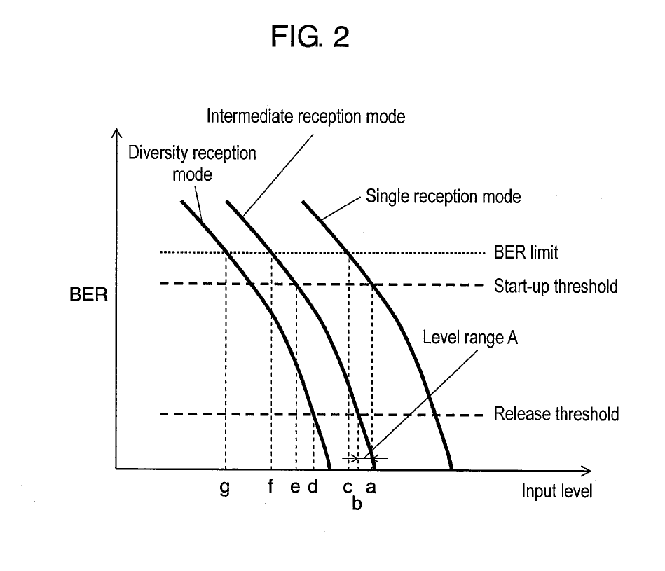

A description is made for the operation of switching with the aid of an intermediate reception mode using FIG. 2. An intermediate reception mode is created so that its reception sensitivity is lower than that in the diversity reception mode and higher than that in the single reception mode. In the example of FIG. 2, reception sensitivity f in the intermediate reception mode is lower than reception sensitivity g in the diversity reception mode and higher than reception sensitivity c in the single reception mode. Here, in terms of switching control between the diversity reception mode and intermediate reception mode, input level e at which the start-up threshold is reached in the intermediate reception mode is lower than input level d at which the release threshold is reached in the diversity reception mode, and thus level range A shown in FIG. 6 does not exist, resulting in no periodical switching occurring. Meanwhile, in terms of switching control between the intermediate reception mode and single reception mode, in level range A determined by input level a at which the start-up threshold is reached in the single reception mode and by input level b at which the release threshold is reached in the intermediate reception mode, periodical switching between the intermediate reception mode and single reception mode occurs. However, input level c at which the BER limit is reached in the single reception mode is lower than input level b, and thus level range B shown in FIG. 6 does not exist, resulting in no reception error occurring even during a period of the single reception mode.

In addition, to eliminate level range A as well, the following method can be used. That is, a fourth reception mode with its reception sensitivity lower than that in the intermediate reception mode and higher than that the single reception mode is newly created, and switching control is performed using the four reception modes in sequence. Further, five or more reception modes may exist.

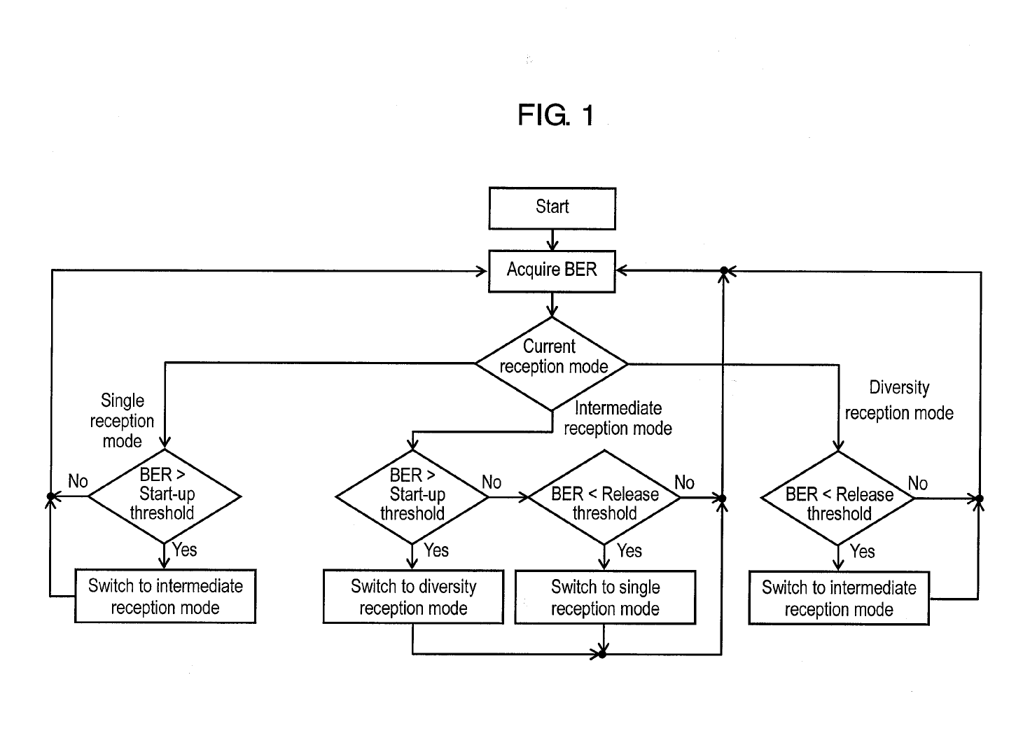

A description is made for a concrete example of controlling with the configuration of this embodiment using FIG. 1, which shows an example of the control method according to the present invention. In the single reception mode after a BER is acquired, controller 9 (refer to FIG. 4) controls so as to switch to the intermediate reception mode if the BER is higher (Yes) than the start-up threshold. In the diversity reception mode, controller 9 controls so as to switch to the intermediate reception mode if the BER is lower (Yes) than the release threshold. In the intermediate reception mode, controller 9 controls so as to switch to the diversity reception mode if the BER is higher (Yes) than the start-up threshold; controls so as to switch to the single reception mode if the BER is lower (Yes) than the release threshold; and does nothing, but the flow returns to the BER acquiring step if the BER is lower (No) than the start-up threshold and higher (No) than the release threshold. With this control flow, switching control can be performed between the three reception modes according to a reception environment, enabling level ranges A and B to be narrowed or eliminated.

From the above-described description, when performing switching control of the reception modes trading off reception sensitivity against power consumption according to a reception environment, using the configuration of this embodiment suppresses a reception error occurring caused by periodical switching, thereby implementing smooth switching control.

Here, in this embodiment, the description is made for the example of switching between the diversity reception mode and single reception mode. However, the present invention is effective in a receiving apparatus with only one series of receiver (i.e. not structured for diversity). That is, in terms of the circuitry of the receiver, smooth switching control is possible in the same way with the aid of an intermediate reception mode when controlling so as to switch the reception modes between the high-sensitivity mode with high reception sensitivity with large power consumption and the power-saving mode with small power consumption with low reception sensitivity according to a reception environment.

In this case, the performance difference in mobile reception characteristics (Reilly characteristic) between the high-sensitivity mode and power-saving mode is generally small or zero. Consequently, adaptive switching between the reception modes is effective near the reception sensitivity level while being ineffective near the mobile reception sensitivity level, which is higher than the reception sensitivity level, resulting in characteristic degradation caused by switching in some cases. To avoid this phenomenon occurring, the adaptive switching control is stopped to enter the power-saving mode when the input level stays beyond a certain level (e.g. higher than the reception sensitivity level). Alternatively, other methods may be used. For example, the receiving apparatus is provided with a movement detector (not shown), and the adaptive switching control is stopped to enter the power-saving mode when the apparatus is moving at a given speed or faster.

Other than an adaptive control of reception modes trading off reception sensitivity against power consumption, when performing adaptive switching control between various types of reception modes (e.g. disturbance characteristic to power consumption, frequency characteristic to power consumption, temperature characteristic to power consumption), creating an intermediate reception mode for respective characteristics eliminates a reception error occurring. More specifically, a reception error is eliminated by setting the disturbance characteristic in the second reception mode (intermediate) so as to be lower than the disturbance characteristic in the first reception mode (high-sensitivity) and higher than that in the third reception mode (power-saving). In the same way, a reception error is eliminated by setting the frequency characteristic in the second reception mode (intermediate) so as to be lower than the frequency characteristic in the first reception mode (high-sensitivity) and higher than that in the third reception mode (power-saving). Further, a reception error is eliminated by setting the temperature characteristic in the second reception mode (intermediate) so as to be lower than the temperature characteristic in the first reception mode (high-sensitivity) and higher than that in the third reception mode (power-saving).

### INDUSTRIAL APPLICABILITY

In a small, mobile receiving terminal, the present invention eliminates frequent switching occurring between the reception modes in diversity reception method where two antennas are used, and either one of the reception signals is selected or both signals are synthesized, to prevent occurrence of a reception error, which is industrially useful.

1. A receiving apparatus comprising:
a receiver capable of switching between:
a high-sensitivity mode;
a power-saving mode having a reception sensitivity lower than that in the high-sensitivity mode; and
an intermediate reception mode having a reception sensitivity lower than that in the high-sensitivity mode and higher than that in the power-saving mode;
a reception environment acquiring unit for acquiring a reception environment and connected to an output side of the receiver; and
a controller for switching the receiver to the intermediate reception mode, in a case where the receiver is in the high-sensitivity mode, when a reception environment acquired by the reception environment acquiring unit becomes better than a release threshold in the high-sensitivity mode; and
switching the receiver to the power-saving mode, in a case where the receiver is in the intermediate reception mode, when a reception environment acquired by the reception environment acquiring unit becomes better than a release threshold in the intermediate reception mode.

2. The receiving apparatus of claim 1, wherein
the controller switches the receiver to the intermediate reception mode, in a case where the receiver is in the power-saving mode, when a reception environment acquired by the reception environment acquiring unit becomes worse than a start-up threshold in the power-saving mode; and
switches the receiver to the high-sensitivity mode, in a case where the receiver is in the intermediate reception mode, when a reception environment acquired by the reception environment acquiring unit becomes worse than a start-up threshold in the intermediate reception mode.

3. The receiving apparatus of claim 1, wherein
the receiver includes an RFGCA;
a gain of the RFGCA in the power-saving mode is lower than that in the high-sensitivity mode; and
a gain of the RFGCA in the intermediate reception mode is lower than that in the high-sensitivity mode and higher than that in the power-saving mode.

4. The receiving apparatus of claim 1, wherein
a current value of the receiver in the power-saving mode is lower than that in the high-sensitivity mode; and
a current value of the receiver in the intermediate reception mode is lower than that in the high-sensitivity mode and higher than that in the power-saving mode.

5. The receiving apparatus of claim 1, wherein
the receiver includes an A/D converter converting an analog signal to a digital signal;
a conversion accuracy of the A/D converter in the power-saving mode is lower than that in the high-sensitivity mode; and
a conversion accuracy of the A/D converter in the intermediate reception mode is lower than that in the high-sensitivity mode and higher than that in the power-saving mode.

6. A receiving apparatus comprising:
a receiver including a first receiver and a second receiver, capable of switching between:
a diversity reception mode in which a signal is received with the first receiver and the second receiver;
a single reception mode in which a signal is received with either one of the first receiver and the second receiver; and
an intermediate reception mode having a reception sensitivity lower than that in the diversity reception mode and higher than that in the single reception mode;
a reception environment acquiring unit for acquiring a reception environment and connected to an output side of the receiver; and
a controller for switching the receiver to the intermediate reception mode, in a case where the receiver is in the diversity reception mode, when a reception environment acquired by the reception environment acquiring unit becomes better than a release threshold in the diversity reception mode; and
switching the receiver to the single reception mode in a case where the receiver is in the intermediate reception mode, when a reception environment acquired by the reception environment acquiring unit becomes better than a release threshold in the intermediate reception mode.

7. The receiving apparatus of claim 6, wherein
the controller switches the receiver to the intermediate reception mode, in a case where the receiver is in the single reception mode, when a reception environment acquired by the reception environment acquiring unit becomes worse than a start-up threshold in the single reception mode, and
switches the receiver to the diversity reception mode, in a case where the receiver is in the intermediate reception mode, when a reception environment acquired by the reception environment acquiring unit becomes worse than a start-up threshold in the intermediate reception mode.

8. The receiving apparatus of claim 6, wherein
the first receiver and the second receiver include RFGCAs, respectively; and
the receiver receives a signal with the first receiver and the second receiver in the intermediate reception mode, and a gain of one or both of the RFGCAs in the intermediate reception mode is lower than that in the diversity reception mode.

9. The receiving apparatus of claim 6, wherein
the receiver receives a signal with the first receiver and the second receiver in the intermediate reception mode, and a current value of one or both of the receivers in the intermediate reception mode is smaller than that in the diversity reception mode.

10. The receiving apparatus of claim 6, wherein
the first receiver and the second receiver have A/D converters converting an analog signal to a digital signal, respectively;
the receiver receives a signal with the first receiver and the second receiver in the intermediate reception mode; and
a conversion accuracy of one or both of the A/D converters in the intermediate reception mode is lower than that in the diversity reception mode.

11. A receiving apparatus comprising:
a receiver capable of switching between a first reception mode, a third reception mode in which the receiving apparatus operates with an operation power lower than that in the first reception mode, and a second reception mode in which the receiving apparatus operates with an operation power lower than that in the first reception mode and higher than that in the third reception mode;
a reception environment acquiring unit for acquiring a reception environment and connected to an output side of the receiver; and
a controller for switching the receiver to the second reception mode, in a case where the receiver is in the first reception mode, when a reception environment acquired by the reception environment acquiring unit becomes better than a release threshold in the first reception mode; and
switching the receiver to the third reception mode, in a case where the receiver is in the second reception mode, when a reception environment acquired by the reception environment acquiring unit becomes better than a release threshold in the second reception mode.

12. The receiving apparatus of claim 11, wherein
the controller switches the receiver to the second reception mode, in a case where the receiver is in the third reception mode, when a reception environment acquired by the reception environment acquiring unit becomes worse than a start-up threshold in the third reception mode; and
switches the receiver to the first reception mode in a case where the receiver is in the second reception mode, when a reception environment acquired by the reception environment acquiring unit becomes worse than a start-up threshold in the second reception mode.

13. The receiving apparatus of claim 11, wherein
a disturbance characteristic in the third reception mode is worse than that in the first reception mode; and
a disturbance characteristic in the second reception mode is worse than that in the first reception mode and better than that in the third reception mode.

14. The receiving apparatus of claim 11, wherein
a frequency characteristic in the third reception mode is worse than that in the first reception mode; and
a frequency characteristic in the second reception mode is worse than that in the first reception mode and better than that in the third reception mode.

15. The receiving apparatus of claim 11, wherein
a temperature characteristic in the third reception mode is worse than that in the first reception mode; and
a temperature characteristic in the second reception mode is worse than that in the first reception mode and better than that in the third reception mode.

16. The receiving apparatus of claim 2, wherein a reception environment at the release threshold in each of the modes is better than that at the start-up threshold in each of the modes.

17. The receiving apparatus of claim 1, further comprising:
a fourth reception mode having a reception sensitivity worse than that in the intermediate reception mode and better than that in the power-saving mode, wherein
the receiving apparatus performs switching control in sequence between the high-sensitivity mode, the intermediate reception mode, the fourth reception mode, and the power-saving mode.

18. The receiving apparatus of claim 6, further comprising:
a fourth reception mode having a reception sensitivity worse than that in the intermediate reception mode and better than that in the single reception mode, wherein
the receiving apparatus performs switching control in sequence between the diversity reception mode, the intermediate reception mode, the fourth reception mode, and the single reception mode.

19. A digital broadcast receiving apparatus comprising:
a receiver capable of switching between a high-sensitivity mode and a low-sensitivity mode having a reception sensitivity lower than that in the high-sensitivity mode;
a reception environment acquiring unit for acquiring an error rate of a reception signal and connected to an output side of the receiver; and
a controller for switching the receiver to the low-sensitivity mode, in a case where the receiver is in the high-sensitivity mode, when an error rate of a reception signal acquired by the reception environment acquiring unit becomes lower than a release threshold; and
switching the receiver to the high-sensitivity mode, in a case where the receiver is in the low-sensitivity mode, when an error rate of a reception signal acquired by the reception environment acquiring unit becomes higher than a start-up threshold higher than the release threshold,
wherein an input level at which switching is performed from the low-sensitivity mode to the high-sensitivity mode is lower than that from the high-sensitivity mode to the low-sensitivity mode.

20. The digital broadcast receiving apparatus of claim 19,
wherein the receiver includes an RFGCA, and
a gain of the RFGCA in the low-sensitivity mode is lower than that in the high-sensitivity mode.

21. The digital broadcast receiving apparatus of claim 19,
wherein a current value of the receiver in the low-sensitivity mode is smaller than that in the high-sensitivity mode.

22. The digital broadcast receiving apparatus of claim 19,
wherein the receiver includes an A/D converter converting an analog signal to a digital signal, and
a conversion accuracy of the A/D converter in the low-sensitivity mode is lower than that in the high-sensitivity mode.

23. A digital broadcast receiving apparatus comprising:
a receiver including a first receiver and a second receiver, capable of switching between:
a diversity reception mode in which a signal is received with the first receiver and the second receiver;
a single reception mode in which a signal is received with either one of the first receiver and the second receiver; and
an intermediate mode having a reception sensitivity lower than that in the diversity reception mode and higher than that in the single reception mode;
a reception environment acquiring unit for acquiring an error rate of a reception signal and connected to an output side of the receiver; and
a controller for switching the receiver to the intermediate mode, in a case where the receiver is in the diversity mode, when an error rate of a reception signal acquired by the reception environment acquiring unit becomes lower than a release threshold; and
switching the receiver to the diversity mode in a case where the receiver is in the intermediate mode, when an error rate of a reception signal acquired by the reception environment acquiring unit becomes higher than a start-up threshold higher than the release threshold,
wherein an input level at which switching is performed from the intermediate mode to the diversity reception mode is lower than that from the diversity reception mode to the intermediate mode.

24. The digital broadcast receiving apparatus of claim 23,
wherein the first receiver and the second receiver include RFGCAs, respectively,
the receiver receives a signal with the first receiver and the second receiver in the intermediate mode, and
a gain of one or both of the RFGCAs in the intermediate mode is lower than that in the diversity reception mode.

25. The digital broadcast receiving apparatus of claim 23,
wherein the receiver receives a signal with the first receiver and the second receiver in the intermediate reception mode, and
a current value of one or both of the receivers in the intermediate reception mode is smaller than that in the diversity reception mode.

26. The digital broadcast receiving apparatus of claim 23,
wherein the first receiver and the second receiver have A/D converters converting an analog signal to a digital signal, respectively,
the receiver receives a signal with the first receiver and the second receiver in the intermediate mode, and
a conversion accuracy of one or both of the A/D converters in the intermediate mode is lower than that in the diversity reception mode.

27. A digital broadcast receiving apparatus comprising:
a receiver capable of switching between:
a first reception mode;
a third reception mode in which the receiving apparatus operates with an operation power lower than that in the first reception mode; and
a second reception mode in which the receiving apparatus operates with an operation power lower than that in the first reception mode and higher than that in the third reception mode;
a reception environment acquiring unit for acquiring an error rate of a reception signal and connected to an output side of the receiver; and
a controller for switching the receiver to the second reception mode, in a case where the receiver is in the first reception mode, when an error rate of a reception signal acquired by the reception environment acquiring unit becomes lower than a release threshold; and
switching the receiver to the first reception mode in a case where the receiver is in the second reception mode, when an error rate of a reception signal acquired by the reception environment acquiring unit becomes higher than a start-up threshold higher than the release threshold,
wherein an input level at which switching is performed from the second reception mode to the first reception mode is lower than that from the first reception mode to the intermediate mode.

28. The digital broadcast receiving apparatus of claim 27, wherein a disturbance characteristic in the third reception mode is worse than that in the first reception mode; and
a disturbance characteristic in the second reception mode is worse than that in the first reception mode and better than that in the third reception mode.

29. The digital broadcast receiving apparatus of claim 27, wherein a frequency characteristic in the third reception mode is worse than that in the first reception mode; and
a frequency characteristic in the second reception mode is worse than that in the first reception mode and better than that in the third reception mode.

30. The digital broadcast receiving apparatus of claim 27, wherein a temperature characteristic in the third reception mode is worse than that in the first reception mode; and
a temperature characteristic in the second reception mode is worse than that in the first reception mode and better than that in the third reception mode.

31. The digital broadcast receiving apparatus of claim 19,
wherein the digital broadcast receiving apparatus has four or more reception modes with different reception sensitivities.

32. The receiving apparatus of claim 2, wherein
the receiver includes an RFGCA;
a gain of the RFGCA in the power-saving mode is lower than that in the high-sensitivity mode; and
a gain of the RFGCA in the intermediate reception mode is lower than that in the high-sensitivity mode and higher than that in the power-saving mode.

33. The receiving apparatus of claim 2, wherein
a current value of the receiver in the power-saving mode is lower than that in the high-sensitivity mode; and
a current value of the receiver in the intermediate reception mode is lower than that in the high-sensitivity mode and higher than that in the power-saving mode.

34. The receiving apparatus of claim 2, wherein
the receiver includes an A/D converter converting an analog signal to a digital signal;
a conversion accuracy of the A/D converter in the power-saving mode is lower than that in the high-sensitivity mode; and
a conversion accuracy of the A/D converter in the intermediate reception mode is lower than that in the high-sensitivity mode and higher than that in the power-saving mode.

35. The receiving apparatus of claim 7, wherein
the first receiver and the second receiver include RFGCAs, respectively; and
the receiver receives a signal with the first receiver and the second receiver in the intermediate reception mode, and a gain of one or both of the RFGCAs in the intermediate reception mode is lower than that in the diversity reception mode.

36. The receiving apparatus of claim 7, wherein
the receiver receives a signal with the first receiver and the second receiver in the intermediate reception mode, and a current value of one or both of the receivers in the intermediate reception mode is smaller than that in the diversity reception mode.

37. The receiving apparatus of claim 7, wherein
the first receiver and the second receiver have A/D converters converting an analog signal to a digital signal, respectively;
the receiver receives a signal with the first receiver and the second receiver in the intermediate reception mode; and
a conversion accuracy of one or both of the A/D converters in the intermediate reception mode is lower than that in the diversity reception mode.

38. The receiving apparatus of claim 12, wherein
a disturbance characteristic in the third reception mode is worse than that in the first reception mode; and
a disturbance characteristic in the second reception mode is worse than that in the first reception mode and better than that in the third reception mode.

39. The receiving apparatus of claim 12, wherein
a frequency characteristic in the third reception mode is worse than that in the first reception mode; and
a frequency characteristic in the second reception mode is worse than that in the first reception mode and better than that in the third reception mode.

40. The receiving apparatus of claim 12, wherein
a temperature characteristic in the third reception mode is worse than that in the first reception mode; and
a temperature characteristic in the second reception mode is worse than that in the first reception mode and better than that in the third reception mode.

41. The receiving apparatus of claim 7, wherein a reception environment at the release threshold in each of the modes is better than that at the start-up threshold in each of the modes.

42. The receiving apparatus of claim 12, wherein a reception environment at the release threshold in each of the modes is better than that at the start-up threshold in each of the modes.

43. The receiving apparatus of claim 2, further comprising:
a fourth reception mode having a reception sensitivity worse than that in the intermediate reception mode and better than that in the power-saving mode, wherein
the receiving apparatus performs switching control in sequence between the high-sensitivity mode, the intermediate reception mode, the fourth reception mode, and the power-saving mode.

44. The receiving apparatus of claim 7, further comprising:
a fourth reception mode having a reception sensitivity worse than that in the intermediate reception mode and better than that in the single reception mode, wherein
the receiving apparatus performs switching control in sequence between the diversity reception mode, the intermediate reception mode, the fourth reception mode, and the single reception mode.
